(19) United States
(12) Patent Application Publication
(10) Pub. No.: US 2024/0391300 A1
(43) Pub. Date: Nov. 28, 2024

(54) THERMAL MANAGEMENT MODULE

(71) Applicant: Hanon Systems, Daejeon (KR)

(72) Inventors: Orest Alexandru Dziubinschi, Dearborn, MI (US); Devon Laird, Commerce Twp., MI (US); Madison Paige Turner, Royal Oak, MI (US); Jeffrey Laplante, Highland, MI (US)

(21) Appl. No.: 18/322,825

(22) Filed: May 24, 2023

(51) Int. Cl. B60H 1/32

(52) U.S. Cl. CPC B60H 1/3229; B60H 1/32281; B60H 2001/3291

(57) ABSTRACT

A module of a thermal management system includes a bracket having an internal heat exchanger, an evaporator, and an accumulator attached thereto. The internal heat exchanger includes a high-pressure side and a low-pressure side. The module includes a first flow of a refrigerant flowing through a first flow path of the module passing through the high-pressure side of the internal heat exchanger, a second flow of the refrigerant flowing through a second flow path of the module passing through, in an order of the second flow, the evaporator, the accumulator, and the low-pressure side of the internal heat exchanger, and a flow of a coolant flowing through a third flow path of the module passing through the evaporator.

### FIELD OF THE INVENTION

The invention relates to a thermal management system of a motor vehicle, and more particularly, a submodule of the thermal management system with the submodule having integrated components of each of a refrigerant circuit and a coolant circuit.

### BACKGROUND

A thermal management system of a vehicle may include a plurality of different fluid circuits configured to manage the characteristics of one or more corresponding fluids. For example, a thermal management system may include at least one refrigerant circuit and/or at least one coolant circuit, each of which includes multiple fluid conveying components arranged in a manner requiring the formation of fluid tight seals at each junction therebetween. Such fluid systems further require the use of fluid lines provided as pipes, hoses, or the like for fluidly connecting the fluid conveying components of each associated fluid circuit.

It has accordingly become increasingly desirable for the components forming a thermal management system of a vehicle to be provided in modular form to facilitate an ease of manufacturing of the vehicle. Such a thermal management system module may include the incorporation therein of multiple components associated with operation of a corresponding coolant system and/or refrigeration system of the vehicle. The thermal management module may be preassembled and then received within a corresponding space within the vehicle while utilizing a minimized number of couplings and connections.

### SUMMARY OF THE INVENTION

In accordance with the present disclosure, an integrated module of a thermal management system has surprisingly been discovered.

According to an embodiment of the present invention, a module configured for installation in a thermal management system having a refrigerant circuit configured to be operable in a heat pump mode includes a bracket, an internal heat exchanger attached to the bracket with the internal heat exchanger including a high-pressure side and a low-pressure side, an evaporator attached to the bracket, and an accumulator attached to the bracket. The module is configured to include a first flow of a refrigerant flowing through a first flow path of the module passing through the high-pressure side of the internal heat exchanger and a second flow of the refrigerant flowing through a second flow path of the module passing through, in an order of the second flow, the evaporator, the accumulator, and the low-pressure side of the internal heat exchanger when the module is installed in the thermal management system and the refrigerant circuit is operable in the heat pump mode.

According to another embodiment of the invention, a thermal management system for a vehicle includes a refrigerant circuit having, in an order of flow of a refrigerant therethrough during a heat pump mode, a compressor, a condenser, a high-pressure side of an internal heat exchanger, an expansion element, an evaporator, an accumulator, and a low-pressure side of the internal heat exchanger. The thermal management system also includes a coolant circuit having a coolant flowing through the evaporator of the refrigerant circuit to exchange heat between the refrigerant and the coolant within the evaporator with the coolant in heat exchange communication with a heat generating component of the vehicle. The internal heat exchanger, the evaporator, and the accumulator are integrated into a module that is configured to be removably coupled to each of the refrigerant circuit and the coolant circuit. The module includes a bracket attached to each of the internal heat exchanger, the evaporator, and the accumulator. The module is configured to include a first flow of the refrigerant flowing through a first flow path of the module passing through the high-pressure side of the internal heat exchanger and a second flow of the refrigerant flowing through a second flow path of the module passing through, in an order of the second flow, the evaporator, the accumulator, and the low-pressure side of the internal heat exchanger. The module is further configured to include a flow of the coolant flowing through a third flow path of the module passing through the evaporator.

### BRIEF DESCRIPTION OF THE DRAWINGS

FIG. 1 is a schematic view of a thermal management system having a thermal management module incorporated therein according to an embodiment of the invention;

FIG. 2 is a rear perspective view of the thermal management module;

FIG. 3 is a front perspective view of the thermal management module;

FIG. 4 is a top perspective view of the thermal management module;

FIG. 5 is a rear perspective view showing a bracket of the thermal management module in isolation;

FIG. 6 is a top plan view of the bracket of FIG. 5;

FIG. 7 is a rear perspective view of a fixture utilized in establishing a fixed position of the thermal management module;

FIG. 8 is a front perspective view of the fixture of FIG. 7;

FIGS. 9 and 10 are side perspective views showing alternative configurations of a bracket and an accumulator of the thermal management module according to another embodiment of the present invention;

FIG. 11 is an elevational cross-sectional and partially schematic view through a thermal management module according to another embodiment of the invention as taken from the perspective of section lines 11-11 in FIG. 13;

FIG. 12 is an elevational cross-sectional and partially schematic view through the thermal management module of FIG. 11 as taken from the perspective of section lines 12-12 in FIG. 13; and

FIG. 13 is an elevational cross-sectional and partially schematic view through the thermal management module of FIG. 11 as taken from the perspective of section lines 13-13 in FIG. 11.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

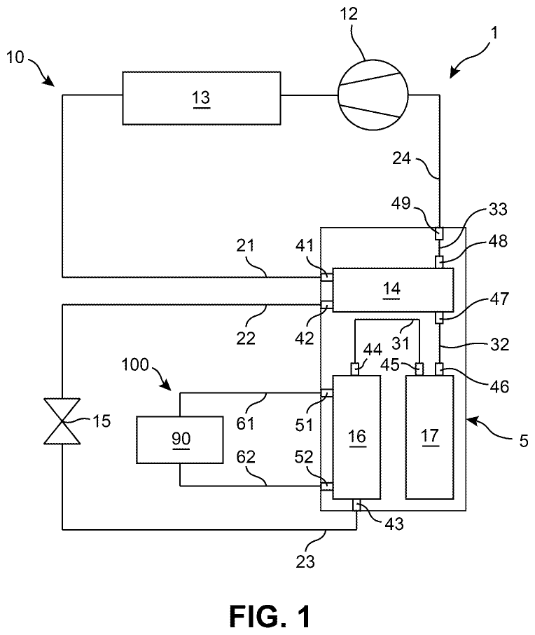

FIG. 1 schematically illustrates a thermal management system 1 comprising a thermal management module 5 according to an embodiment of the present invention. The thermal management system 1 includes a refrigerant circuit 10 in heat exchange communication with a coolant circuit 100. The thermal management system 1 may be incorporated in a vehicle, such as a hybrid or electric vehicle relying upon stored electrical power to provide heat to various components of the vehicle and/or air to be delivered to the passenger cabin of the vehicle via the operation of the thermal management system 1 and the corresponding refrigerant circuit 10 and coolant circuit 100. However, the present invention may be utilized in any vehicular application without necessarily departing from the scope of the present invention. The thermal management system 1 may itself be modular in configuration with the described thermal management module 5 forming one submodule among a plurality of submodules that cooperate with each other to form the desired structure and flow configurations of the thermal management system 1. However, the thermal management module 5 as shown and described herein operates in substantially the same manner and provides substantially the same benefits regardless of whether the thermal management system 1 is comprised of additional submodules or cooperating modular components.

The refrigerant circuit 10 includes, in an order of flow of a refrigerant during a heat pump mode of operation, a compressor 12, a condenser/gas cooler 13, a high-pressure side of an internal heat exchanger 14, an expansion element 15, an evaporator/chiller 16, an accumulator 17, and a low-pressure side of the internal heat exchanger 14. The thermal management module 5 of the present invention includes the integration of each of the internal heat exchanger 14, the evaporator 16, and the accumulator 17 of the refrigerant circuit 10 into a single structure capable of being removed from or otherwise provided independently of the remainder of the thermal management system 1, thereby facilitating independent manufacturing, testing, and/or maintenance of the components associated with the thermal management module 5 as described hereinafter. The refrigerant circuit 10 is shown in substantially simplified schematic form in FIG. 1 and may include additional flow paths, valves, and/or components from those illustrated without necessarily departing from the scope of the present invention, so long as the same general relationships are present between the components forming the thermal management module 5 and the remainder of the thermal management system 1 as described hereinafter.

The compressor 12 may be any compressor suitable for vehicular applications such as a reciprocating compressor or a scroll compressor, as desired. The compressor 12 is configured to compress the refrigerant of the refrigerant circuit 10 when in a substantially low pressure and gaseous phase to increase the temperature and pressure of the refrigerant when passing through the compressor 12. The refrigerant accordingly exits the compressor as a relatively high temperature and high pressure gaseous phase.

The condenser 13 is a heat exchanger configured to remove heat from the high temperature and high pressure refrigerant exiting the compressor 12. The refrigerant exiting the condenser 13 may be partially liquid and partially gaseous in phase. The condenser 13 may be in heat exchange communication with any other fluid suitable for removing heat from the refrigerant within the condenser 13. In some embodiments, the condenser 13 may be a water-cooled condenser (WCC) in fluid communication with a liquid coolant of an associated fluid system of the vehicle, such as a coolant system utilized in cooling various components of the vehicle. In other embodiments, the condenser 13 may be a radiator configured to exchange heat with ambient air. In still other embodiments, the condenser 13 may be a heating heat exchanger disposed within an HVAC casing (not shown) of the vehicle, and may be configured to heat air delivered to a passenger compartment of the vehicle.

The internal heat exchanger 14 is configured to provide heat exchange communication between a high pressure portion of the refrigerant passing through the high-pressure side of the internal heat exchanger 14 at a position upstream of the expansion member 15 and the evaporator 16 and a low pressure portion of the refrigerant passing through the low-pressure side of the internal heat exchanger 14 at a position downstream of the expansion member 15 and evaporator 16. The high pressure portion of the refrigerant has a relatively greater temperature than the low pressure portion of the refrigerant at the internal heat exchanger 14, hence the heat exchange occurring via the internal heat exchanger 14 causes a temperature of the high pressure portion of the refrigerant to be decreased and also causes a temperature of the low pressure portion of the refrigerant to be increased. The decreasing of the temperature of the high pressure portion of the refrigerant may lead to a subcooling of the high pressure portion of the refrigerant below the saturation temperature thereof, which in turn leads to a cooling capacity of the evaporator 16 being increased via the heat exchange occurring within the internal heat exchanger 14 in comparison to a refrigerant circuit devoid of such internal heat exchange. In some circumstances, the low pressure portion of the refrigerant may also be superheated to a temperature above the evaporation temperature of the refrigerant via the heat exchange occurring within the internal heat exchanger 14 prior to entry into a low-pressure side of the compressor 12.

The expansion element 15 may refer to any structure or device for contracting and then expanding a flow of the refrigerant therethrough such that a temperature and a pressure of the refrigerant are each lowered following passage therethrough. The expansion element 15 is accordingly configured to lower a temperature and a pressure of the refrigerant passing therethrough prior to entry into the evaporator 16 and following passage through the low-pressure side of the internal heat exchanger 14. The expansion element 15 may be a fixed orifice or may be an adjustable expansion device wherein a flow cross-section through the expansion element 15 may be varied to alter the drop in pressure and temperature of the refrigerant passing therethrough, as is necessary. If utilized, the varying of the flow cross-section through the expansion element 15 may be passive or active, as desired.

The evaporator 16 is a heat exchanger configured to add heat to the low temperature and low pressure refrigerant prior to entering the low-pressure side of the compressor 12. The refrigerant exiting the evaporator 16 may be gaseous in phase or may be a combination of gaseous and liquid in phase. The evaporator 16 is also in fluid and heat exchange communication with a coolant originating from the coolant circuit 100. The coolant may be a liquid coolant, such as water, utilized in exchanging heat with at least one heat generating component 90 in direct or indirect heat exchange communication with the coolant of the coolant circuit 100. For example, the at least one heat generating component 90 may refer to a battery of the vehicle, an electric motor of the vehicle, or to a heat generating electrical component associated with the operation of the vehicle and/or the thermal management system 1. When water is utilized as the coolant, the evaporator 16 may be representative of what is typically referred to as a water-cooled evaporator (WCE). The evaporator 16 may alternatively be referred to as a chiller 16 of the refrigerant circuit 10 by virtue of the manner in which the evaporator 16 may be utilized in cooling the heat generating component 90 of the coolant circuit 100.

The coolant circuit 100 is configured to provide the coolant to the evaporator 16 at a temperature greater than a temperature of the refrigerant within the evaporator 16 to ensure that the refrigerant is heated within the evaporator 16 during a heat pump mode of operation of the refrigerant circuit 10. The coolant circuit 100 is shown in simplified form in FIG. 1 and may include additional components such as a pump (not shown) and any valve arrangements (not shown) necessary for prescribing a desired flow configuration through the heat generating component 90 and the evaporator 16, as desired. The coolant circuit 100 may be configured to be operational in either of two different flow directions with respect to passage of the coolant through the evaporator 16 while remaining within the scope of the present invention.

In some embodiments, the refrigerant circuit 10 may include the branching of the refrigerant to two or more of the evaporators/chillers (not shown) at the disclosed position of the evaporator 16, as necessary, if the refrigerant circuit 10 is associated with the heat regulation of additional components or spaces of the vehicle, such as being in heat exchange communication with air to be delivered to the passenger compartment of the vehicle via the positioning of an evaporator within an associated HVAC casing (not shown) of the thermal management system 1. Such an alternative flow path for the refrigerant may include a bypassing of the components 14, 16, 17 forming the thermal management module 5 at a position upstream of the evaporator 16 and a rejoining of the bypassed refrigerant upstream of the compressor 12, as desired. Such a branching of the refrigerant circuit 10 around the thermal management module is accordingly within the scope of the present invention.

The accumulator 17 is configured to receive and accumulate any liquid refrigerant remaining within the flow of the otherwise gaseous refrigerant following the heating of the refrigerant within the evaporator 16, thereby preventing the undesired entry of liquid refrigerant into a compression chamber of the compressor 12. A level of the liquid refrigerant within the accumulator 17 may vary in accordance with the operational conditions of the thermal management system 1 including the operational speed of the compressor 12 and the heat exchanger demands placed on the thermal management system 1. That is, the accumulator 17 may be utilized in storing excess liquid refrigerant that is necessary for operating the refrigerant circuit 10 during high-demand conditions utilizing a higher rate of refrigerant flow.

The thermal management module 5 includes a plurality of fluid connections where various fluid lines of the thermal management system 1 are coupled to the components 14, 16, 17 forming the thermal management module 5 in a fluid-tight manner. As used herein, a fluid line may refer to any pipe, conduit, hose, or the like utilized in conveying a fluid between adjacent fluid-conveying components of the thermal management system 1 in a manner not intended to have a significant impact on a temperature and/or pressure of the fluid conveyed therethrough. Such a fluid line may generally include a circular cross-section that is extended along a desired length having the necessary straight and curved segments for arranging the fluid line around adjacent components and between the desired fluid connections formed at each end of the fluid line. As used herein, each fluid connection refers to any structure or feature facilitating the coupling of one of the fluid lines to one of the components 14, 16, 17 of the thermal management module 5 in the desired fluid-tight manner. The fluid connection may refer to an adapter, fitting, or assembly disposed at the junction of the fluid line and one of the fluid-conveying components 14, 16, 17, such as a block fitting assembly including the use of cooperating male and female blocks for compressing a sealing element at a junction of one of the fluid lines and an inlet and/or outlet of one of the fluid conveying components 14, 16, 17. Such a block fitting assembly may be considered to be a form of removable or releasable fluid connection configured for disconnecting and reconnecting a fluid line thereto via use of an associated threaded fastener assembly of the block fitting assembly. As another example, the fluid connection may refer to a position where one of the fluid lines is securely affixed to one of the components 14, 16, 17 via an aggressive joining process that is substantially non-removable/releasable, such as brazing or welding. Attachment structures and methods in addition to those shown and described herein may be utilized in assemblies the joints of the thermal management module 5 while remaining within the scope of the present invention.

As shown throughout FIGS. 1-4, the illustrated embodiment of the invention includes a first refrigerant fluid connection 41 provided at an inlet to the high-pressure side of the internal heat exchanger 14 and a second refrigerant fluid connection 42 provided at an outlet therefrom. The first refrigerant fluid connection 41 is configured to fluidly couple the high-pressure side of the internal heat exchanger 14 to a first refrigerant circuit fluid line 21 disposed upstream of the high-pressure side of the internal heat exchanger 14 and conveying refrigerant after having passed through the condenser 13 while the second refrigerant fluid connection 42 is configured to fluidly couple the high-pressure side of the internal heat exchanger 14 to a second refrigerant circuit fluid line 22 disposed downstream of the high-pressure side of the internal heat exchanger 14 and conveying the refrigerant towards the downstream-arranged expansion element 15.

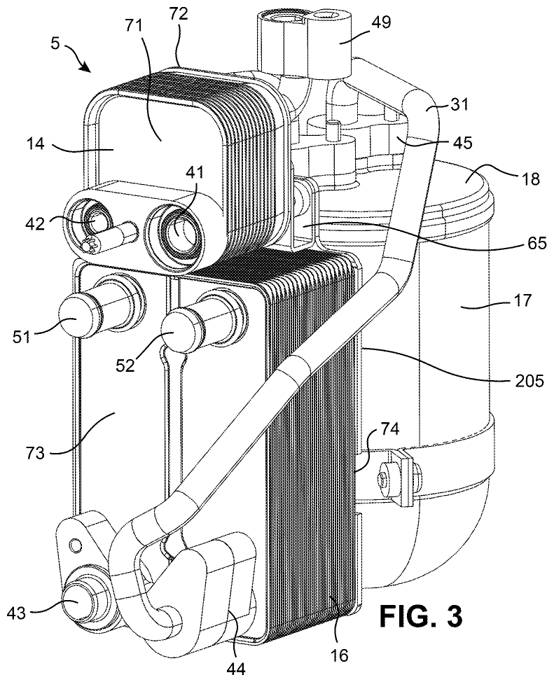

In the illustrated embodiment, each of the first and second refrigerant fluid connections 41, 42 is provided as a block fitting assembly wherein a male block is inserted into a corresponding female block with a sealing element compressed therebetween. As shown in FIG. 3, each of the first and second refrigerant fluid connections 41, 42 may be at least partially formed in an integrated block structure that is common to each of the refrigerant fluid connections 41, 42. However, independently provided block fitting assemblies may be utilized for each refrigerant fluid connection 41, 42 without departing from the scope of the present invention. Each of the refrigerant fluid connections 41, 42 may include one of the male/female blocks securely affixed to an end of one of the refrigerant circuit fluid lines 21, 22 and the other of the male/female blocks securely affixed to a desired position on the internal heat exchanger 14.

The internal heat exchanger 14 is shown throughout as being a plate-type heat exchanger having a plurality of stacked plates with the spaces formed between adjacent ones of the plates forming alternating first flow passages for a first fluid (the high-pressure refrigerant from the high-pressure side of the internal heat exchanger 14) and second flow passages for a second fluid (the low-pressure refrigerant from the low pressure side of the internal heat exchanger 14), wherein heat is transferred between the first and second fluids via heat transfer through the plates defining the first and second flow passages. When such a plate configuration is utilized, each of the refrigerant fluid connections 41, 42 may be associated with a corresponding manifold chamber formed within the internal heat exchanger 14. For example, the first refrigerant fluid connection 41 may be positioned and oriented to be axially aligned with and directly fluidly coupled to an inlet manifold chamber formed within the internal heat exchanger 14 and extending in a direction of stacking of the plurality of the plates while the second refrigerant fluid connection 42 may be positioned and oriented to be axially aligned with and directly fluidly coupled to an outlet manifold chamber formed within the internal heat exchanger 14 and extending in the direction of stacking of the plurality of the plates. The inlet manifold chamber distributes the refrigerant to the flow passages and the outlet manifold chamber recombines the refrigerant after having passed through the flow passages. The flow passages of the internal heat exchanger 14 may include a U-shaped or otherwise serpentine flow pattern when extending between the inlet and outlet manifold chambers. The direction of extension of each such manifold chamber may be substantially perpendicular to the plane of each of the plates forming the stacked plurality of plates of the internal heat exchanger 14. Flow through each of the manifold chambers may accordingly be perpendicular to the general direction of flow through each of the flow passages connecting the manifold chambers. Each of the manifold chambers may be formed by the cooperation of axially aligned openings formed through adjacent ones of the plates. Each of the refrigerant fluid connections 41, 42 may be disposed along an outermost one of the plates forming the internal heat exchanger 14 that acts as an outer cover plate 71 thereof, wherein the outer cover plate 71 provides direct fluid communication between the corresponding fluid connection 41, 42 and an aligned one of the manifold chambers.

The internal heat exchanger 14 may further include surface area increasing features for increasing a heat exchange capacity thereof. Such surface area increasing features may be provided as corrugated fin structures disposed within the flow passages formed between adjacent plates forming the internal heat exchanger 14. However, alternative features may be utilized, such as dimples or other flow baffles formed in the plates to intrude into the flow passages, as desired.

A third refrigerant fluid connection 43 is provided at an inlet to the evaporator 16 and a fourth refrigerant fluid connection 44 is provided at an outlet from the evaporator 16 with respect to the flow of the refrigerant therethrough. The third refrigerant fluid connection 43 is configured to fluidly couple the inlet of the evaporator 16 to a third refrigerant circuit fluid line 23 disposed upstream of the evaporator 16 for conveying the refrigerant after having passed through the expansion element 15 while the fourth refrigerant fluid connection 44 is configured to fluidly couple the outlet of the evaporator 16 to an inlet end of a first module fluid line 31 extending between the outlet side of the evaporator 16 and a downstream-arranged inlet side of the accumulator 17.

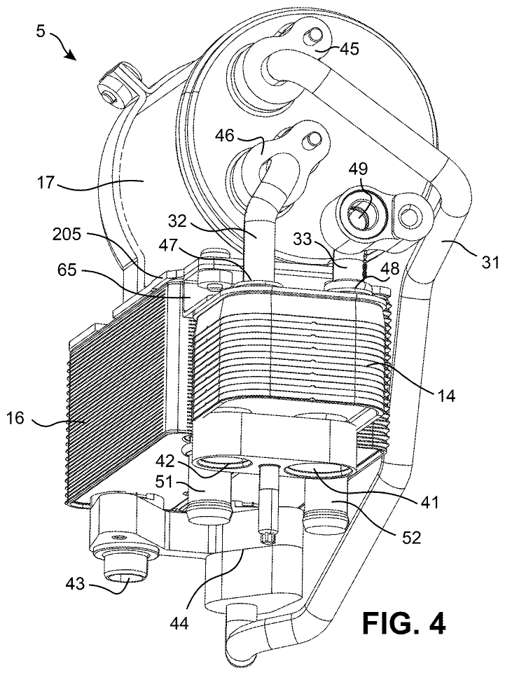

Each of the third and fourth refrigerant fluid connections 43, 44 is again provided as a block fitting assembly wherein a male block is inserted into a corresponding female block with a sealing element compressed therebetween. The third refrigerant fluid connection 43 may include a male or female block securely affixed to the evaporator 16 that is configured to be coupled to the other of a male or female block securely affixed to an end of the third refrigerant circuit fluid line 23 and the fourth refrigerant fluid connection 44 may include a male or female block securely affixed to the evaporator 16 that is configured to be coupled to the other of a male or female block securely affixed to the inlet end of the first module fluid line 31. As shown in FIG. 4, each of the third and fourth refrigerant fluid connections 43, 44 may be at least partially formed in an integrated block structure that is common to each of the refrigerant fluid connections 43, 44, although independently provided block structures may alternatively be utilized without departing from the scope of the present invention.

The evaporator 16 is shown throughout as being a plate-type heat exchanger having a plurality of stacked plates with the spaces formed between adjacent ones of the plates forming alternating first flow passages for a first fluid (the refrigerant after being expanded within the expansion element 15) and second flow passages for a second fluid (the coolant originating from the coolant circuit 100), wherein heat is transferred between the first and second fluids via heat transfer through the plates defining the first and second flow passages. When such a plate configuration is utilized, each of the refrigerant fluid connections 43, 44 may be associated with a corresponding manifold chamber formed within the evaporator 16. For example, the third refrigerant fluid connection 43 may be positioned and oriented to be axially aligned with and directly fluidly coupled to an inlet manifold chamber formed within the evaporator 16 and extending in a direction of stacking of the plurality of the plates while the fourth refrigerant fluid connection 44 may be positioned and oriented to be axially aligned with and directly fluidly coupled to an outlet manifold chamber formed within the evaporator 16 and extending in the direction of stacking of the plurality of the plates. The direction of extension of each such manifold chambers may be substantially perpendicular to the plane of each of the plates forming the stacked plurality of plates of the evaporator 16. Flow through each of the manifold chambers may accordingly be perpendicular to the general direction of flow through each of the flow passages connecting the manifold chambers. The flow passages of the evaporator 16 may include a U-shaped or otherwise serpentine flow pattern when extending between the inlet and outlet manifold chambers for the refrigerant. Each of the manifold chambers may be formed by the cooperation of axially aligned openings formed through adjacent ones of the plates. Each of the refrigerant fluid connections 43, 44 may be disposed along an outermost one of the plates forming the evaporator 16 that acts as an outer cover plate 73 thereof, wherein the outer cover plate 73 provides direct fluid communication between the corresponding fluid connection 43, 44 and an aligned one of the manifold chambers.

The evaporator 16 further includes a first coolant fluid connection 51 and a second coolant fluid connection 52. As noted above, the coolant may flow through the evaporator 16 in either possible flow direction while remaining within the scope of the present invention, hence either of the first or second coolant fluid connections 51, 52 may form an inlet or an outlet into the evaporator 16 for the coolant, although a changing of the flow direction of the coolant through the evaporator 16 may result in an altering of a flow configuration present between the refrigerant and the coolant within the evaporator 16. Each of the coolant fluid connections 51, 52 is shown as a cylindrical structure configured for coupling to a corresponding end fitting or adapter. Specifically, the first coolant fluid connection 51 is configured for removable coupling to a corresponding end fitting or adapter of a first coolant fluid line 61 of the coolant circuit 100 and the second coolant fluid connection 52 is configured for removable coupling to a corresponding end fitting or adapter of a second coolant fluid line 62 of the coolant circuit 100. The first and second coolant fluid connections 51, 52 may be disposed at an opposite end of the evaporator 16 than the third and fourth refrigerant fluid connections 43, 44 to prescribe a desired flow configuration between the refrigerant and coolant. The first and second coolant fluid connections 51, 52 may be formed on the outer cover plate 73 of the evaporator 16 with the outer cover plate 73 providing direct fluid communication between each of the coolant fluid connections 51, 52 and an aligned manifold chamber.

A fifth refrigerant fluid connection 45 is provided at the inlet into the accumulator 17 and a sixth refrigerant fluid connection 46 is provided at an outlet therefrom. The fifth refrigerant fluid connection 45 is configured to fluidly couple the inlet of the accumulator 17 to an outlet end of the first module fluid line 31 while the sixth refrigerant fluid connection 46 is configured to fluidly couple the outlet of the accumulator 17 to an inlet end of a second module fluid line 32 extending between the outlet of the accumulator 17 and a downstream-arranged inlet of the low-pressure side of the internal heat exchanger 14.

The accumulator 17 may be substantially cylindrical in shape and may include a circular cap 18 disposed at an upper end thereof, and each of the refrigerant fluid connections 45, 46 may be disposed on the exposed surface of the cap 18 such that the refrigerant enters and exits the accumulator 17 at the upper end thereof. That is, the refrigerant fluid connections 45, 46 may be disposed at an end of the accumulator 17 configured to be an uppermost end thereof, with respect to the vertical direction of gravity when the thermal management module 5 is installed for operational use, for ensuring that liquid refrigerant accumulates in an opposing lower end of the accumulator 17. Each of the refrigerant fluid connections 45, 46 may be integrated directly into the cap 18, as desired. The lower end of the accumulator 17 disposed opposite the cap 18 may be substantially semi-spherical in configuration, as desired. Once again, each of the refrigerant fluid connections 45, 46 is shown as a form of block fitting assembly having cooperating male and female blocks for compressing a sealing element therebetween.

The first module fluid line 31 is shown as having multiple straight segments interposed between multiple curved segments to provide a desired shape thereto when connecting the fourth refrigerant fluid connection 44 of the evaporator 16 to the fifth refrigerant fluid connection 45 of the accumulator 17. The first module fluid line 31 may be provided with a limited degree of flexibility to allow the first module fluid line 31 to be properly routed between the refrigerant fluid connections 44, 45 in a manner avoiding any adjacent components of the thermal management system 1 or other adjacent systems of the associated vehicle. The first module fluid line 31 may be arranged to transport the refrigerant exiting the evaporator 16 from a lower end thereof, at a similar position to the lower end of the accumulator 17, to the upper end of the accumulator 17 having the cap 18, which includes transporting the refrigerant vertically upwardly and laterally when the thermal management module 5 is in the installed configuration.

A seventh refrigerant fluid connection 47 is provided at the inlet into the low-pressure side of the internal heat exchanger 14 and an eighth refrigerant fluid connection 48 is provided at the outlet from the low-pressure side thereof. The seventh refrigerant fluid connection 47 is configured to fluidly couple the inlet of the low-pressure side of the internal heat exchanger 14 to an outlet end of the second module fluid line 32 while the eighth refrigerant fluid connection 48 is configured to fluidly couple the outlet of the low-pressure side of the internal heat exchanger 14 to an inlet end of a third module fluid line 33.

The thermal management module 5 may include the disclosed configuration of the evaporator 16 relative to the accumulator 17 to result in the first module fluid line 31 having a greater length when extending between the fourth refrigerant fluid connection 44 and the fifth refrigerant fluid connection 45 than does the second module fluid line 32 when extending between the sixth refrigerant fluid connection 46 and the seventh refrigerant fluid connection 47. This second module fluid line 32 preferably includes the shorter length to ensure that a minimized pressure drop is experienced by the refrigerant when being transported from the accumulator 17 to the low-pressure side of the internal heat exchanger 14. The relatively longer length of the first module fluid line 31 does not have as great an impact on the pressure drop experienced by the refrigerant than would be experienced within the second module fluid line 32 due to the manner in which the refrigerant may be partially liquid in phase when passing through the first module fluid line 31 as opposed to be purely gaseous in phase after exiting the accumulator 17.

In the illustrated embodiment, each of the seventh and eight refrigerant fluid connections is provided as a non-removable connection where the end of each of the corresponding module fluid lines 32, 33 is securely affixed to an inner cover plate 72 of the internal heat exchanger 14 disposed opposite the first and second fluid refrigerant connections 41, 42 of the outer cover plate 71. Each of the seventh and eighth refrigerant fluid connections 47, 48 may be formed by an aggressive joining process, such as brazing or welding, as non-limiting examples. However, the present invention is not necessarily limited to the use of non-removable connections for the seventh and eighth refrigerant fluid connections 47, 48, and alternative fluid connections may instead be utilized, including a removable connection such as one of the block fitting assemblies shown and described herein.

A ninth refrigerant fluid connection 49 is provided at the outlet end of the third module fluid line 33 and is configured to fluidly couple the outlet end of the third module fluid line 33 to a fourth refrigerant circuit fluid line 24 disposed downstream of the low pressure side of the internal heat exchanger 14 while leading towards an inlet side of the compressor 12. However, the third module fluid line 33 and the ninth refrigerant fluid connection 49 may be provided optionally, and the thermal management module 5 may alternatively be provided in the absence thereof to result in the eighth refrigerant fluid connection 48 being directly fluidly coupled to the fourth refrigerant circuit fluid line 24, as desired, while remaining within the scope of the present invention. For example, the third module fluid line 33 may be removed and the eighth refrigerant fluid connection 48 may be integrated directly into the structure of the internal heat exchanger 14, such as integrating a male or female block into the inner cover plate 72 thereof. If utilized, the third module fluid line 33 may be provided to be substantially rigid to establish a substantially fixed position of the ninth refrigerant fluid connection 49 relative to the internal heat exchanger 14, or may include some degree of flexibility to aid in making the necessary connection with the fourth refrigerant fluid line 24.

The thermal management module 5 further includes a bracket 200 configured to establish a substantially fixed position and orientation of each of the components 14, 16, 17 forming the module 5 relative to each other, thereby establishing a desired position and configuration of each of the fluid connections 41, 42, 43, 49, 51, 52 configured for connection to an external fluid line 21, 22, 24, 61, 62 when installing the module 5 into a corresponding vehicle. In some embodiments, the module 5 may be secured in position within the vehicle and supported via substantially rigid connections formed at any combination of the externally disposed fluid connections 41, 42, 43, 49, 51, 52 and the external fluid lines 21, 22, 24, 61, 62. In other embodiments, the bracket 200 may include additional structure (not shown in the present embodiment) for facilitating a removable coupling of the bracket 200 to a frame or other rigidly affixed component of the vehicle, such as having openings formed therein that are configured for receiving threaded fasteners or the like that couple the bracket 200 to the vehicle in a substantially rigid and immovable manner. However, the bracket 200, and the module 5 more generally, may be affixed in position relative to the vehicle using substantially any method or structure, including any combination of the methods described, while remaining within the scope of the present invention. However, as discussed hereinafter, it may be desirable to exclusively utilize removable coupling methods regarding any of the externally disposed fluid connections 41, 42, 43, 49, 51, 52 and/or any coupling structures associated with the bracket 200 in order to facilitate the removal of the entirety of the module 5 from the vehicle as a single integrated structure.

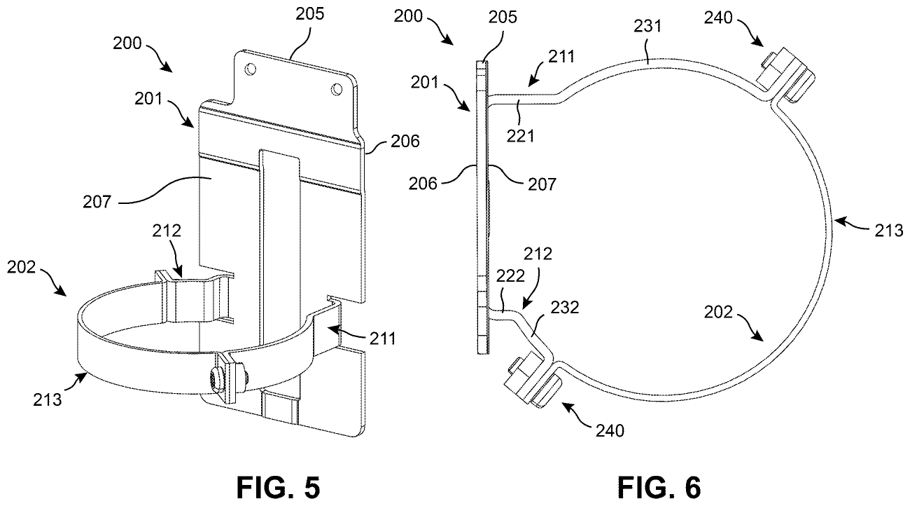

The bracket 200, which is shown in isolation in FIGS. 5 and 6, may include at least a heat exchanger attachment portion 201 and an accumulator attachment portion 202. The heat exchanger attachment portion 201 refers to a portion of the bracket 200 configured for attaching the internal heat exchanger 14 and the evaporator 16 thereto while the accumulator attachment portion 202 refers to a portion of the bracket 200 configured for attaching the accumulator 17 thereto. In the present embodiment, the heat exchanger attachment portion 201 is provided as a substantially planar plate 205 that is configured to be arranged in an upright vertical orientation when the module 5 is installed in the corresponding vehicle, such as shown from the perspective of FIG. 5. The plate 205 includes a first face 206 and an oppositely arranged second face 207.

The first face 206 may be configured for coupling the evaporator 16 to the bracket 200. More specifically, the present embodiment includes an inner cover plate 74 of the evaporator 16, formed opposite the outwardly disposed outer cover plate 73 thereof, as being coupled to the first face 206 of the plate 205 via a non-removable attachment method, such as welding or brazing. However, the second cover plate 74 may alternatively include structure that facilitates a removable attachment of the evaporator 16 to the bracket 200. For example, the inner cover plate 74 may include openings (formed through a non-active region thereof) aligned with corresponding openings formed through the plate 205 for receiving threaded fasteners therethrough, or the inner cover plate 74 and the plate 205 may include complimentary structure for establishing a snap-fit connection therebetween, as non-limiting examples.

In the present embodiment, the internal heat exchanger 14 further includes an attachment structure 65 for establishing the attachment of the internal heat exchanger 14 to the bracket 200. Specifically, the attachment structure 65 is shown as a substantially U-shaped and rigid bracket structure having a first leg securely affixed to a second cover plate 72 of the internal heat exchanger 14, such as by brazing or welding, and an opposing second leg having openings formed therethrough that align with corresponding openings formed through the plate 205 adjacent an upper end thereof. A distance present between the opposing legs of the U-shaped attachment structure 65 may be selected to position the first and second refrigerant fluid connections 41, 42 at a similar or same lateral distance away from the bracket 200 as the fluid connections 43, 44, 51, 52 associated with the evaporator 16 when the internal heat exchanger 14 is provided to include a smaller stacking height than the evaporator 16, as depicted in the present embodiment. The aligned openings may accordingly receive a threaded fastener assembly for establishing the secure and fixed position of the internal heat exchanger 14 relative to the bracket 200. However, the internal heat exchanger 14 is not limited to the use of the additional attachment structure 65 for attaching the internal heat exchanger 14 to the bracket 200, and may instead be attached securely and rigidly to the bracket 200 via any of the methods or structures discussed with respect to the evaporator 16, including the use of non-removable attachment methods such as welding or brazing, or removable attachment methods such as the use of complimentary structures facilitating a snap-fit connection or a threaded assembly connection between the internal heat exchanger 14 and the bracket 200.

The accumulator attachment portion 202 may include a first segment 211, a second segment 212, and a third segment 213 that cooperate with one another to form a substantially cylindrical shape configured to surround and compressively grasp an outer surface of the cylindrical accumulator 17 in order to securely affix a position and orientation of the accumulator 17 relative to the bracket 200. The first segment 211 extends away from the second face 207 of the plate 205 and includes a first spacing portion 221 and a first arcuate portion 231. The second segment 212 similarly extends away from the second face 207 of the plate 205 and includes a second spacing portion 222 and a second arcuate portion 232. The third segment 213 extends arcuately in a manner such that the first arcuate portion 231 of the first segment 211, the second arcuate portion 232 of the second segment 212, and the third segment 213 all cooperate to form the cylindrical shape corresponding to that of the accumulator 17. The third segment 213 may be coupled to the first and second segments 211, 212 at the respective ends thereof via threaded fastener assemblies 240, which may be utilized in tightening the grasp of the accumulator attachment portion 202 for securing the configuration of the accumulator 17 relative thereto. The third segment 213 may extend through a 180° arc to facilitate a lateral removal of the accumulator 17 therefrom when the third segment 213 is removed from the remaining segments 211, 212. The accumulator attachment portion 202 accordingly facilitates a removable attachment of the accumulator 17 to the bracket 200 via the ability to loosen or remove the third segment 213 relative to the remaining segments 211, 212.

The presently disclosed embodiment accordingly includes a beneficial configuration wherein the evaporator 16 is securely and non-removably attached to the bracket 200 while the internal heat exchanger 14 and the accumulator 17 are removably attached to the bracket 200, thereby resulting in the ability to disassemble the module 5 into three independent components capable of being removed, serviced, or replaced independently of one another, wherein the bracket 200 may be considered an integrated component of the evaporator 16 that is removed or replaced in conjunction with the evaporator 16. The integration of the evaporator 16 and the bracket 200 accordingly removes one component from the assembly of the module 5 in comparison to the use of removable attachment methods for all three components 14, 16, 17.

However, the present invention is not limited to the disclosed configuration. As an alternative example, the internal heat exchanger 14 may be non-removably attached to the bracket 200 and the evaporator 16 may be removably attached thereto via a switching of the structures utilized in attaching each respective heat exchanger 14, 16 to the bracket 200. As another alternative example, all three of the internal heat exchanger 14, the evaporator 16, and the accumulator 17 may be removably attached to the bracket 200, thereby allowing for the bracket 200 to be removed from the remaining components 14, 16, 17 for servicing/replacement or for the components 14, 16, 17 to be removed from the bracket 200 while the bracket 200 is coupled to a frame of the vehicle, depending on the circumstances.

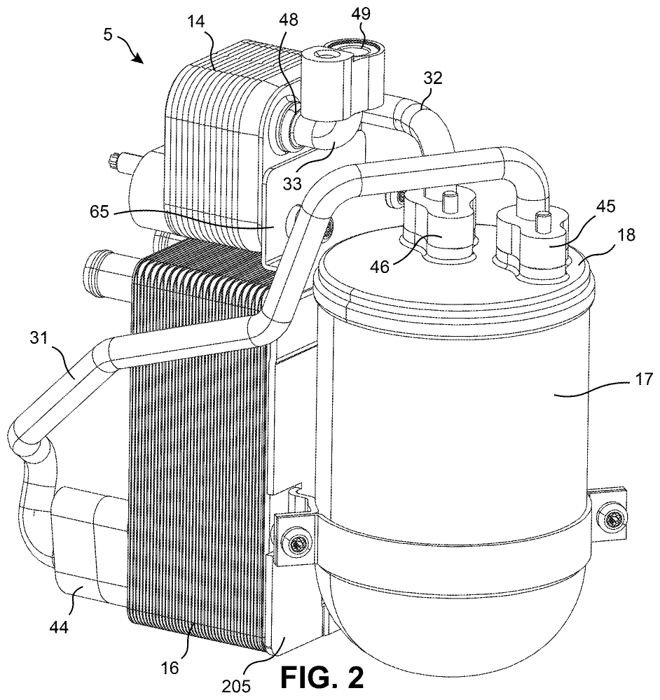

The structure of the bracket 200 and the arrangement of the components 14, 16, 17 relative thereto as shown in FIGS. 2-6 is also not considered to be limiting to the present invention. For example, the evaporator 16 and the internal heat exchanger 14 do not necessarily require disposition on a common face of the plate 205, and may be disposed on opposing faces of the plate 205, as desired. If disposed on a common face of the bracket 200, the internal heat exchanger 14 and the evaporator 16 may alternatively be disposed laterally relative to one another, rather than being disposed in the vertical direction as shown in the present figures. As another example, the bracket 200 may be extended to position all three of the components 14, 16, 17 on a common face of the bracket 200, as desired.

As mentioned throughout, the thermal management module 5 may beneficially be manufactured independently of the remainder of the thermal management system 1 and may further be removable from the remainder of the thermal management system 1 as an integrated component thereof. The ability to manufacture the module 5 independently of the remainder of the thermal management system 1 may facilitate the manufacture and/or assembly of those components 14, 16, 17 forming the module 5 at a location remote from the manufacture and/or assembly of at least some or all of the remaining components forming the thermal management system 1 due to the standardized position and orientation of each of the components 14, 16, 17, the associated fluid lines 31, 32, 33, and the associated connections 41, 42, 43, 44, 45, 46, 47, 48, 49, 51, 52 forming the module 5. The configuration of the removable and non-removable connections and attachments of the described components 14, 16, 17 also facilitates an ease of servicing/replacing each individual component absent the modification or removal of the remaining components forming the module 5. The module 5 is also configured to include minimized distances present between adjacent components 14, 16, 17 to result in the module fluid lines 31, 32 being minimized in weight and length while a packaging space occupied by the components 14, 16, 17 forming the module 5 as a whole is reduced relative to a non-modular configuration.

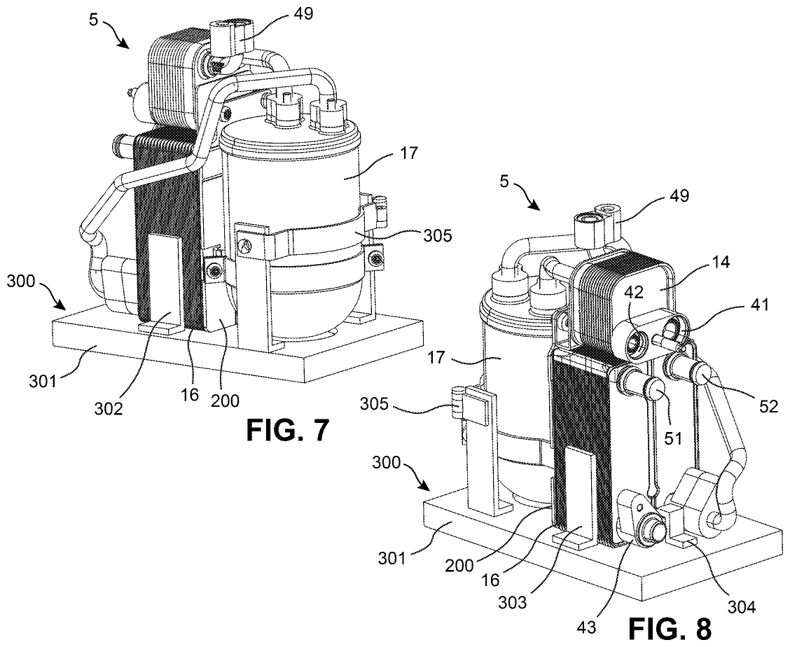

As shown in FIGS. 7 and 8, another benefit provided by the standardized configuration of the components 14, 16, 17 of the module 5 is the ability to utilize a similarly standardized fixture 300 when testing or servicing the components 14, 16, 17 of the module 5. The fixture 300 includes a base 301 and a plurality of braces 302, 303, 304, 305 configured to delimit translation or rotation of the module 5 when retained by the fixture 300. The base 301 forms a surface on which the module 5 rests to delimit translation in the vertical direction thereof and the braces 302, 303, 304, 305 extend from the base 301 to surround the module 5 in a manner restricting translation thereof in directions perpendicular to the vertical direction as well as restricting rotation of the module 5 relative to the fixture 300. The braces 302, 303, 304, 305, as illustrated, include a first side brace 302 engaging a first lateral side of the evaporator 16, a second side brace 303 engaging an opposing second lateral side of the evaporator 16, a first end brace 304 engaging the outer cover plate 73 of the evaporator 16 at one longitudinal end of the module 5, and a second end brace 305 engaging the accumulator 17 at an opposing second longitudinal end of the module 5. The illustrated configuration of the fixture 300 may include the module 5 being slid laterally to a position engaging the first end brace 304 before adjusting a swinging gate of the second end brace 305 to a position engaging the accumulator 17. As shown, the swinging gate of the second end brace 304 may include a shape and configuration corresponding to an outer surface of the accumulator 17 to cause the swinging gate to restrictively engage the outer surface of the accumulator 17 when the swinging gate is adjusted to a closed position, including a locking pin or other locking mechanism affixing the swinging gate in the closed configuration thereof. However, the fixture 300 is not limited to the specified configuration of the base 301 or braces 302, 303, 304, 305, as the standardized configuration of the module 5 may be configured for cooperation with substantially any combination of structures configured to restrict movement of the module 5 relative thereto when the module 5 is retained by the fixture 300.

The disclosed configuration of the module 5 also beneficially facilitates an ability to easily test any one of three different fluid flow paths formed through the module 5 independently of the remainder of the thermal management system 1, such as performing testing on the module 5 following manufacturing thereof and prior to installation into the remainder of the thermal management system 1. The three different flow paths refer to a first refrigerant flow path, a second refrigerant flow path, and a coolant flow path. The first refrigerant flow path includes the first refrigerant fluid connection 41, an interior of the internal heat exchanger 14 along the high-pressure side thereof, and the second refrigerant fluid connection 42. The second refrigerant flow path includes the third refrigerant fluid connection 43, an interior of the evaporator 16, the fourth refrigerant fluid connection 44, the first module fluid line 31, the fifth refrigerant fluid connection 45, an interior of the accumulator 17, the sixth refrigerant fluid connection 46, the second module fluid line 32, the seventh refrigerant fluid connection 47, an interior of the low-pressure side of the internal heat exchanger 14, the eighth refrigerant fluid connection 48, the third module fluid line 33, and the ninth refrigerant fluid connection 49. As mentioned previously, in some embodiments the second refrigerant flow path may conclude at the eighth refrigerant fluid connection 48 in the absence of the third module fluid line 33 and the ninth refrigerant fluid connection 49, as desired. The coolant flow path includes the first coolant fluid connection 51, an interior of the evaporator 16, and the second coolant fluid connection 52.

Each of the disclosed flow paths may be pressurized in order to determine whether any leaks are present at any point along each respective flow path due to the manner in which each flow path is provided independently within the module 5 in the absence of direct fluid communication between the different flow paths at positions within the module 5. Appropriate sensors may also be disposed at each of the end-disposed fluid connections associated with one of the flow paths to determine the characteristics of each respective fluid prior to and after having passed through each flow path of the module 5, such as testing for a pressure or temperature difference in either fluid after traversing the respective flow path. Such testing may be performed during use of a structure such as the fixture 300 for establishing desired positions and orientations of the flow paths relative to the corresponding testing equipment or setup.

The disclosed configuration of the module 5 accordingly facilitates an ability to performance test each of the components 14, 16, 17, the fluid lines 31, 32, 33, and the fluid connections 41, 42, 43, 44, 45, 46, 47, 48, 49, 51, 52 independently of the remainder of the thermal management system 1 while isolating the testing to limited segments thereof. That is, multiple components and joints can be tested simultaneously without introducing difficulty in determining the origin of a leak or other discovered problem due to the limited length of each tested flow path within the module 5 in comparison to the total length of the flow path for each respective fluid through the respective refrigerant circuit 10 or coolant circuit 100. This ability to test each flow path from positions where each flow path joins the remainder of the thermal management system 1 also facilitates the independent manufacture of the module 5 as such testing may be easily performed at a remote location and/or prior to assembly of the remainder of the thermal management system 1 without compromising the ability to determine such leaks or other concerns associated with the flow paths formed through the module 5.

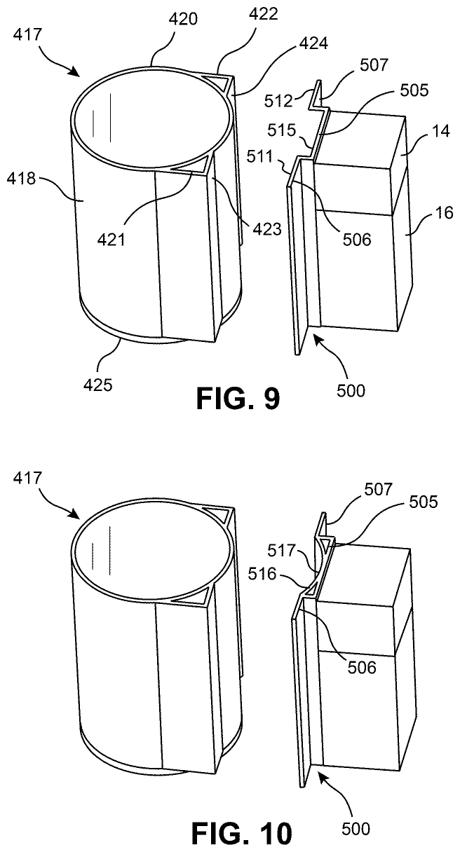

FIG. 9 illustrates one possible variation to the structure of the module 5 for attaching a modified accumulator 417 to a modified bracket 500, thereby eliminating the use of the accumulator attachment portion 202 of the bracket 200. A main body 418 of the accumulator 417 may be formed in an extrusion process and may include a cylindrical portion 420, a first attachment portion 421 extending outwardly from the cylindrical portion 420 towards a first lateral side thereof, and a second attachment portion 422 extending outwardly from the cylindrical portion 420 opposite the first attachment portion 421 and towards a second lateral side thereof. The first attachment portion 421 defines a first attachment surface 423 and the second attachment portion 422 defines a second attachment surface 424, wherein the first and second attachment surfaces 423, 424 are arranged co-planar relative to one another along a vertically extending plane that is arranged parallel to the planes defined by the plates forming the heat exchangers 14, 16, which is also parallel to a plane arranged tangential to the surface of the cylindrical portion 420 disposed closest to the bracket 500. The first and second attachment surfaces 423, 424 are provided to extend outwardly away from the circular shape of the cylindrical portion 420, hence the attachment surfaces 423, 424 are themselves not circular or cylindrical in configuration. In the provided embodiment, each of the attachment portions 421, 422 is substantially triangular in configuration, but any shape establishing a desired position and orientation of the attachments surfaces 423, 424 may be utilized while remaining within the scope of the present invention. Following the extrusion of the main body 418, a lower cap 425 may be attached to a bottom surface of the main body 418 to delimit an interior thereof in the vertical downward direction while a cap (not shown in FIG. 9) similar to the cap 18 may be added at the upper surface of the main body 418 for establishing the refrigerant fluid connections 45, 46 thereon.

The bracket 500 includes a vertically arranged plate 505 having a first flanged portion 506 extending from a first lateral side of the plate 505 and a second flanged portion 507 extending from a second lateral side of the plate 505 opposite the first lateral side thereof. The first flanged portion 506 is substantially L-shaped in configuration and includes a first attachment surface 511 offset from and arranged parallel to the plate 505 and the second flanged portion 507 is similarly substantially L-shaped in configuration and includes a second attachment surface 512 offset from and arranged parallel to the plate 505. The first and second attachment surfaces 511, 512 are arranged to be co-planar with each other at the position offset from the plate 505 to cause the plate 505 and the straddling flanged portions 506, 507 to form a substantially rectangular cross-sectioned opening 515. The internal heat exchanger 14 and the evaporator 16 may be coupled to a face of the bracket 500 opposite the accumulator 417 using any of the attachment methods described hereinabove while remaining within the scope of the present invention.

An attachment of the accumulator 417 to the bracket 500 includes the first attachment surface 423 of the accumulator 417 being placed into contact with the first attachment surface 511 of the bracket 500, the second attachment surface 424 of the accumulator 417 being placed into contact with the second attachment surface 512 of the bracket 500, and segment of the cylindrical portion 420 received in the opening 515 of the bracket 500. When in such a position, the accumulator 417 may be removably attached or non-removably attached to the bracket 500. In some embodiments, each pairing of one of the flanged portions 506, 507 with a contacting one of the attachment portions 421, 422 may include aligned openings for receiving a threaded fastener assembly representative of a removably attachment of the accumulator 417 to the bracket 500. As another example, each pairing may include complimentary structure for establishing a snap-fit or other removable or releasable attachment. Lastly, the co-planar paired surfaces may be directly attached to each other using an aggressive joining method, such as brazing or welding. The extension of the accumulator 417 shape to include a non-circular or non-cylindrical outer circumferential surface towards the bracket 500 accordingly facilitates the ability to easily attach the accumulator 417 to the bracket 500 while establishing a desired position and orientation thereof.

FIG. 10 discloses the bracket 500 as including a slight modification wherein an arcuate surface 516 of the bracket 500 extends between the opposing flanged portions 506, 507 in a direction towards the accumulator 417. The arcuate surface 516 defines an opening 517 in the bracket 500 between the flanged portions 506, 507 having the cross-sectional shape of a segment of a circle, which corresponds in shape and size to a segment of the cylindrical portion 420 of the accumulator 417 extending outwardly beyond the first and second attachment surfaces 423, 424 thereof. The segment of the cylindrical portion 420 is accordingly received within and nests within the opening 517 when the accumulator 417 is attached to the bracket 500 using any of the methods described above with reference to the embodiment of FIG. 9.

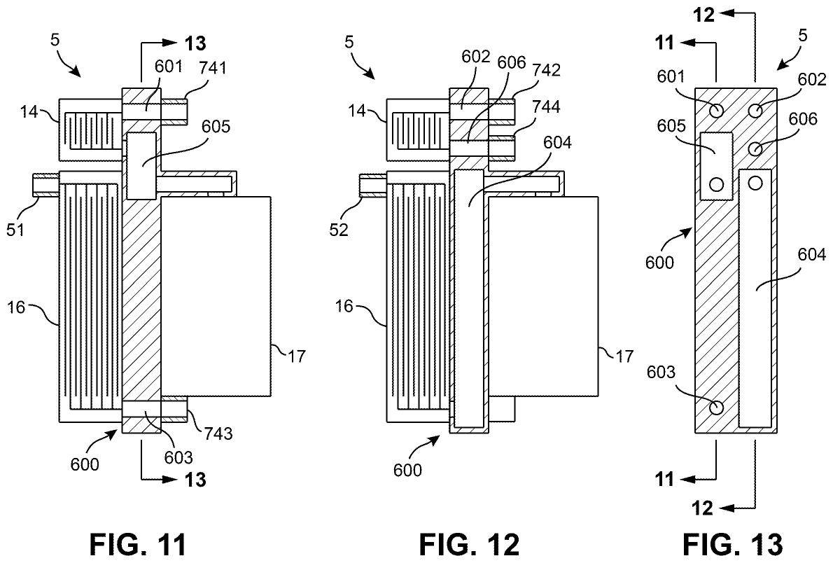

Referring now to FIGS. 11-13, a bracket 600 according to another embodiment of the present invention is disclosed. The bracket 600 differs from the previously disclosed brackets 200, 500 in that the bracket 600 is configured to include at least a portion of the first refrigerant flow path and/or the second refrigerant flow path formed within an interior compartment of the bracket 600. The use of the bracket 600 in conveying the refrigerant through at least one of the refrigerant flow paths may be desirable to accommodate certain packaging configurations of the thermal management system 1 wherein it may be desirable to move one of the fluid connections 41, 42, 43, 44 disposed on one of the outer cover plates 71, 72 of FIGS. 2-4 to an opposing surface of the corresponding heat exchanger 14, 16, wherein the modified bracket may act as the inner cover plate of each respective heat exchanger 14, 16 at which each corresponding refrigerant fluid connection 41, 42, 43, 44 is disposed. As another example, the refrigerant may be conveyed through the bracket 600 to eliminate the use of one of the module fluid lines 31, 32 extending between the components 14, 16, 17 of the module 5, or to shorten the length of one or both of the module fluid lines 31, 32 by transporting the refrigerant to a location adjacent the corresponding fluid connections via passage through the interior of the bracket 600.

The bracket 600 shown in FIGS. 11-13 illustrates each of these concepts in disclosing a bracket 600 having a flow chamber associated with each inlet and/or outlet into one of the components 14, 16, 17 of the module 5, thereby maximizing the number of distinct occurrences where the refrigerant is caused to flow through the interior of the bracket 600 when entering or exiting any of the components 14, 16, 17 associated with the module 5. Specifically, the bracket 600 is shown as including a first flow chamber 601 fluidly coupling a first refrigerant fluid connection 741 to an inlet manifold of a high-pressure side of the internal heat exchanger 14, a second flow chamber 602 fluidly coupling an outlet manifold of the high-pressure side of the internal heat exchanger 14 to a second refrigerant fluid connection 742, a third flow chamber 603 fluidly coupling a third refrigerant fluid connection 743 to an inlet manifold of the evaporator 16, a fourth flow chamber 604 fluidly coupling an outlet manifold of the evaporator 16 to an inlet into the accumulator 17, a fifth flow chamber 605 fluidly coupling an outlet from the accumulator 17 to an inlet manifold of the low-pressure side of the internal heat exchanger 14, and a sixth flow chamber 606 fluidly coupling an outlet manifold of the low-pressure side of the internal heat exchanger 14 to a fourth refrigerant fluid connection 744. In the provided example, each of the flow chambers 601, 602, 603, 606 is provided as a through-hole extending between opposing faces of the bracket 600 to allow each respective refrigerant fluid connection 741, 742, 743, 744 to provided on a face of the bracket 600 opposite the face thereof having the heat exchangers 14, 16 disposed thereon. In contrast, each of the flow chambers 604, 605 extends at least partially in the vertical direction (when the module 5 is installed in a vehicle) for communicating the refrigerant to different heights within the bracket 600 while also communicating the refrigerant between the opposing faces of the bracket 600. In this example, the fourth flow chamber 604 acts as a replacement flow path for the first module fluid line 31 while the second flow chamber 605 acts as a replacement flow path for the second module fluid line 32.

However, it should be readily apparent to one skilled in the art that any combination of complimentary features of the bracket 200 and the bracket 600 may be incorporated into a modified bracket having the same general flow configuration as disclosed with respect to either of the brackets 200, 600 while remaining within the scope of the present invention. For example, any of the through-holes 601, 602, 603, 606 disclosed in FIGS. 11-13 may be omitted where it is instead desirable to make such fluid connections on the corresponding outer cover plate of one of the heat exchangers 14, 16, thereby eliminating the need to route the refrigerant through the bracket 600. As another example, some of the fluid connections may be made with the outer cover plate of one of the heat exchangers 14, 16 while some of the remaining fluid connections are formed at the face of the bracket 600 opposite the heat exchangers 14, 16. As another example, the modified bracket may include substantially similar connections to that disclosed with reference to FIGS. 2-4 while utilizing one or both of the vertically extending flow chambers 604, 605 in eliminating the need for one or both of the module fluid lines 31, 32, or in shortening the length of one of the module fluid lines 31, 32.

The bracket 600 is also shown in FIGS. 11 and 12 as having the coolant fluid connections 51, 52 disposed to a side of the evaporator 16 opposite the bracket 600 in similar fashion to the bracket 200 of FIGS. 2-4. However, the bracket 600 may be modified to include additional flow chambers (not shown) that are provided independently of the refrigerant flow chambers 601, 602, 603, 604, 605, 606 for similarly routing the coolant through the bracket 600, when attempting to recreate the same flow configuration of the evaporator 16 as disclosed in FIGS. 2-4.

From the foregoing description, one ordinarily skilled in the art can easily ascertain the essential characteristics of this invention and, without departing from the spirit and scope thereof, can make various changes and modifications to the invention to adapt it to various usages and conditions.

1. A module configured for installation in a thermal management system having a refrigerant circuit configured to be operable in a heat pump mode, the module comprising:
a bracket;
an internal heat exchanger attached to the bracket, the internal heat exchanger including a high-pressure side and a low-pressure side;
an evaporator attached to the bracket; and
an accumulator attached to the bracket, wherein the module is configured to include a first flow of a refrigerant flowing through a first flow path of the module passing through the high-pressure side of the internal heat exchanger and a second flow of the refrigerant flowing through a second flow path of the module passing through, in an order of the second flow, the evaporator, the accumulator, and the low-pressure side of the internal heat exchanger when the module is installed in the thermal management system and the refrigerant circuit is operable in the heat pump mode.

2. The module of claim 1, wherein the module is further configured to include a flow of a coolant flowing through a third flow path of the module passing through the evaporator when the module is installed in the thermal management system, the flow of the coolant configured to exchange heat with the second flow of the refrigerant within the evaporator.

3. The module of claim 2, wherein the thermal management system includes a coolant circuit conveying the coolant therethrough, wherein the coolant circuit includes a heat generating component transferring heat to the coolant.

4. The module of claim 2, wherein the coolant is liquid water.

5. The module of claim 2, wherein the first flow path, the second flow path, and the third flow path are provided independently of each other within the module.

6. The module of claim 1, wherein a temperature of the first flow of the refrigerant is greater within the internal heat exchanger than a temperature of the second flow of the refrigerant therein.

7. The module of claim 1, wherein the second flow path of the module is disposed downstream of the first flow path of the module with respect to a flow of the refrigerant through the refrigerant circuit when operable in the heat pump mode.

8. The module of claim 1, further comprising a first module fluid line connecting the evaporator to the accumulator along the second flow path.

9. The module of claim 8, further comprising a second module fluid line connecting the accumulator to the low-pressure side of the internal heat exchanger.

10. The module of claim 9, wherein the first module fluid line includes at least one of a greater length than the second module fluid line and/or a greater number of changes in flow direction therealong than the second module fluid line to result in a pressure drop experienced by the refrigerant when passing through the first module fluid line being greater than a pressure drop experienced by the refrigerant when passing through the second module fluid line.

11. The module of claim 1, wherein the evaporator is non-removably attached to the bracket.

12. The module of claim 11, wherein the internal heat exchanger is provided as a submodule of the module that is removably attached to the bracket to facilitate testing of the internal heat exchanger independently of the evaporator and the accumulator.

13. The module of claim 12, wherein the internal heat exchanger is removably attached to the bracket adjacent an upper end of the evaporator with respect to a vertical direction.

14. The module of claim 1, wherein at least a portion of the first flow path is defined by a flow chamber formed within the bracket.

15. The module of claim 1, wherein at least a portion of the second flow path is defined by a flow chamber formed within the bracket.

16. The module of claim 15, wherein the flow chamber fluidly couples an outlet of the evaporator to an inlet of the accumulator.

17. The module of claim 15, wherein the flow chamber fluidly couples an outlet of the accumulator to an inlet of the low-pressure side of the internal heat exchanger.

18. The module of claim 1, wherein the accumulator includes an attachment portion extending outwardly from an outer circumferential surface of a cylindrical portion thereof, wherein the attachment portion is configured to be attached to the bracket.

19. A thermal management system for a vehicle, the thermal management system comprising:
a refrigerant circuit having, in an order of flow of a refrigerant therethrough during a heat pump mode, a compressor, a condenser, a high-pressure side of an internal heat exchanger, an expansion element, an evaporator, an accumulator, and a low-pressure side of the internal heat exchanger;
a coolant circuit having a coolant flowing through the evaporator of the refrigerant circuit to exchange heat between the refrigerant and the coolant within the evaporator, the coolant in heat exchange communication with a heat generating component of the vehicle;
wherein the internal heat exchanger, the evaporator, and the accumulator are integrated into a module that is configured to be removably coupled to each of the refrigerant circuit and the coolant circuit, the module comprising a bracket attached to each of the internal heat exchanger, the evaporator, and the accumulator, wherein the module is configured to include a first flow of the refrigerant flowing through a first flow path of the module passing through the high-pressure side of the internal heat exchanger and a second flow of the refrigerant flowing through a second flow path of the module passing through, in an order of the second flow, the evaporator, the accumulator, and the low-pressure side of the internal heat exchanger, and wherein the module is further configured to include a flow of the coolant flowing through a third flow path of the module passing through the evaporator.

20. The thermal management system of claim 19, wherein the first flow path, the second flow path, and the third flow path are provided independently of each other within the module.
